(19) United States
(12) Patent Application Publication
(10) Pub. No.: US 2005/0178402 A1
(43) Pub. Date: Aug. 18, 2005

(54) Methods and apparatus for cleaning and drying a work piece

(76) Inventors: R. Marshall Stowell, Wilsonville, OR (US); Tim Cleary, Portland, OR (US); Michael J. Janicki, West Linn, OR (US); Mark Dinneen, Portland, OR (US)

Correspondence Address: INGRASSIA FISHER & LORENZ, P.C., 7150 E. CAMELBACK, STE. 325, SCOTTSDALE, AZ, 85251, US

(21) Appl. No.: 10/778,799

(22) Filed: Feb. 12, 2004

(51) Int. Cl. B08B 3/02

(52) U.S. Cl. 134/1.3; 134/25.4; 134/33; 134/148; 134/153; 134/902; 134/186; 134/183

(57) ABSTRACT

Methods and apparatus are provided for the cleaning and drying of a work piece. The apparatus comprises a carrier configured to carry a work piece that has a surface. The apparatus further comprises a press plate having a first surface and a second surface. During a cleaning process, the carrier, the press plate, or both, is configured to move relative to the other. The press plate is disposed a distance from the surface of the work piece such that, when a cleaning fluid is disposed between the work piece and the press plate, the surface tension of the cleaning fluid maintains a meniscus between the work piece and the press plate. A mega-sonic transducer is coupled to the second surface of the press plate.

### FIELD OF THE INVENTION

The present invention generally relates to cleaning and drying of semiconductor wafers, and more particularly relates to mega-sonic cleaning and gas/vapor drying of semiconductor wafers.

### BACKGROUND OF THE INVENTION

Chemical mechanical polishing (CMP) is a technique which has been conventionally used for the planarization of semiconductor wafers. Furthermore, chemical mechanical polishing is often used in the formation of microelectronic devices to provide a substantially smooth, planar surface suitable for subsequent fabrication processes such as photoresist coating and pattern definition. A typical chemical mechanical polishing apparatus suitable for planarizing a semiconductor surface generally includes a wafer carrier configured to support, guide, and apply pressure to a wafer during the polishing process, a polishing compound such as a slurry to assist in the removal of material from the surface of the wafer, and a polishing surface such as a polishing pad.

A wafer surface is generally polished by moving the surface of the wafer to be polished relative to the polishing surface in the presence of a polishing compound. In particular, the wafer is placed in a carrier such that the surface to be polished is placed in contact with the polishing surface, and the polishing surface and the wafer are moved relative to each other while slurry is supplied to the polishing surface.

After a wafer is subjected to the CMP process, there will remain on the wafer a residue of the polishing slurry and particles of the material removed during the process. This necessitates that the wafer be cleaned and dried before further processing can take place. While the above refers to CMP processes, it should be understood that, additionally, other processes such as plasma etching, may also leave a residue on a wafer that necessitates cleaning and drying of the wafer. Any residue left on a wafer may cause defects on the wafer such that subsequent processing steps will not be properly or completely performed, resulting in reductions in yields due to inoperable devices.

The cleaning of the wafer typically involves, for example, scrubbing, spraying cleaning, musing and the like. Currently, one of the well known methods for cleaning wafers utilizes the application of mega-sonic energy created by a transducer and channeled by some mega-sonic applicator to a fluid medium where the acoustic energy travels through the medium to the wafer surface, imparting energy useful in cleaning and dislodging particles. Mega-sonic applicators can come in a variety of styles including quartz tanks for batch clean, quartz rods, coated metal plates or ceramic plates.

After a wafer has been wet cleaned, the wafer is further processed to remove water or cleaning agents so as to prevent the water and/or cleaning agent from drying and leaving a contaminating residue on the wafer surface. Spin drying is a process commonly used to remove liquid residue from the surface of a wafer. During spin drying, the cleaning liquid is applied to the center of a rapidly spinning wafer. The centrifugal force created by the spinning wafer forces the applied liquid quickly to the edge of the wafer and subsequently off the wafer.

Previously available cleaning and drying processes have proven unsatisfactory for a number of reasons. For example, the general utility of previously available cleaning and drying processes is limited depending on the properties of the surfaces that are being cleaned and dried. Liquids wet a hydrophilic surface, i.e., a thin layer of liquid spreads relatively evenly over the wafer surface and flows off the edge of the wafer upon the application of centrifugal forces as described above. As the wafer dries, only a small amount of residue is left on the wafer surface. Due to the need for faster integrated circuitry, however, there has been increased use of low dielectric constant (K) dielectrics such as carbon-doped oxides and spin-on materials (e.g., polyimide) that exhibit hydrophobic characteristics, that is, they repel liquids. Liquids bead on hydrophobic surfaces, and as the hydrophobic nature of the material increases, the contact angle of a bead of liquid on the surface increases. This beading phenomenon results in greater amounts of liquid residing on smaller defined areas of the wafer surface. While spin drying, the resulting centrifugal force on each bead of liquid causes each bead to roll toward the edge of the wafer. Unfortunately, as the bead rolls toward the edge of the wafer, it leaves droplets of water behind that dry, leaving contaminants on the surface. These contaminants can appear as radial lines or streaks corresponding to the trail of droplets left by the bead as it rolled toward the wafer's edge. The amount of contaminant left on the hydrophobic surface exceeds that left on a hydrophilic surface because of the beading and because the failure to “wet” the surface results in inferior cleaning. Accordingly, local areas of contaminants on wafers surfaces that are hydrophobic, or both hydrophilic and hydrophobic, exhibit significant reduction in yield, overload of metrology systems, and create problems in devices produced on the wafer.

Previously available cleaning and drying processes also have proven unsatisfactory because of the amount of cleaning fluids commonly required in the processes. To achieve adequate cleaning and drying, a significant amount of cleaning fluids typically are sprayed on to the wafer from a nozzle disposed above the wafer. Such significant amounts of cleaning fluids can be costly. In addition, such significant amounts of cleaning fluids may run counter to environmental regulations. Solvents, such as isopropyl alcohol liquid and vapor, acetone liquid and vapor, and the like, often are sprayed on to the wafer to reduce the surface tension of the cleaning fluids. However, the amounts of solvents used may be restricted by environmental regulations.

Moreover, such spraying of the cleaning fluids on the wafer may cause “misting,” wherein the cleaning fluids atomize upon impact with the wafer surface or surfaces of the cleaning apparatus. This mist can redeposit on the wafer after it is cleaned and dried, again resulting in particulate contamination, spotting, and corrosion.

Accordingly, it is desirable to provide a cleaning and drying process and apparatus that efficiently and quickly clean and dry wafers. In addition, it is desirable to provide a cleaning and drying process and apparatus that uses a minimum amount of cleaning fluid. It also is desirable to provide a cleaning and drying process and apparatus that minimizes the redeposition of moisture and particulates on the wafer. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

The present invention will hereinafter be described in conjunction with the following drawing figures, wherein like numerals denote like elements, and

FIG. 1 is a cross-sectional view of a cleaning and drying apparatus in accordance with an exemplary embodiment of the present invention;

FIG. 2 is a top view of an exemplary embodiment of the press plate of the cleaning and drying apparatus of FIG. 1;

FIG. 3 is a cross-sectional view of the cleaning and drying apparatus of FIG. 1 with drying fluid flowing to the surface of a wafer;

FIG. 4 is a cross-sectional view of the cleaning and drying apparatus of FIG. 1 during a drying process of a wafer surface formed of a hydrophilic material;

FIG. 5 is a cross-sectional view of the cleaning and drying apparatus of FIG. 1 during a drying process of a wafer surface formed of a hydrophobic material;

FIG. 6 is a cross-sectional view of a cleaning and drying apparatus in accordance with another exemplary embodiment of the present invention;

FIG. 7 is a cross-sectional view of a cleaning and drying apparatus in accordance with a further exemplary embodiment of the present invention;

FIG. 8 is a cross-sectional view of a cleaning and drying apparatus in accordance with yet another exemplary embodiment of the present invention;

FIG. 9 is a cross-sectional view of a cleaning and drying apparatus in accordance with yet a further exemplary embodiment of the present invention; and

FIG. 10 is a cross-sectional view of a cleaning and drying apparatus in accordance with another exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

For purposes of illustration only, the invention will be described as it applies to the apparatus and methods for cleaning and drying a semiconductor wafer. It is not intended, however, that the invention be limited to these illustrative embodiments; instead, the invention is applicable to a variety of processes and processing apparatus and to the processing and handling of many types of work pieces.

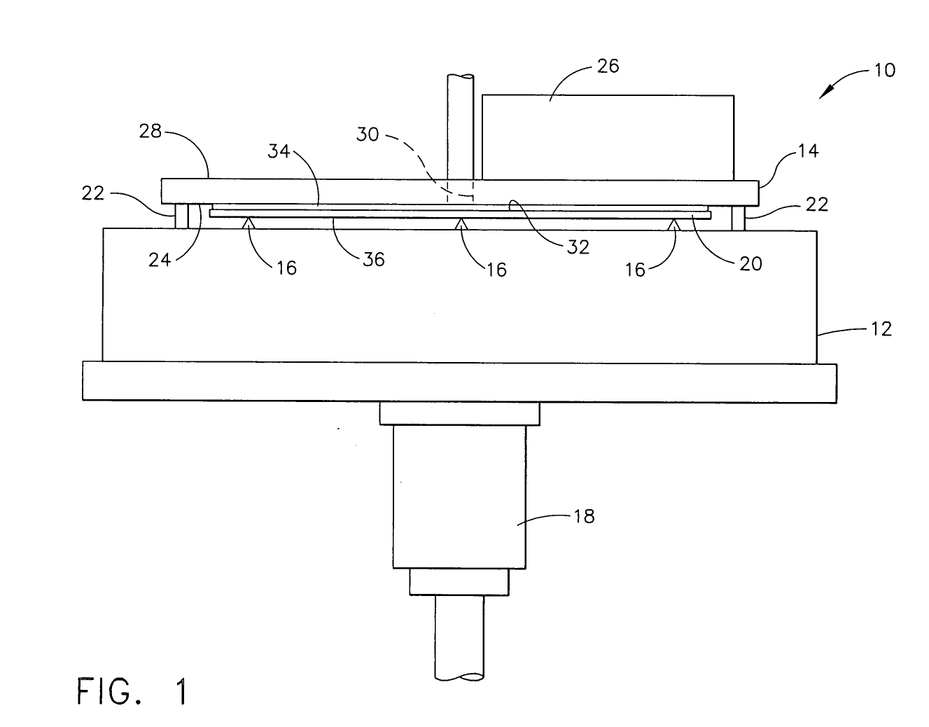

Referring to FIG. 1, an apparatus 10 for cleaning and drying a first surface 32 of wafer 20 in accordance with an exemplary embodiment of the invention is provided. Apparatus 10, as described below, provides for the sequential cleaning and drying of wafer 20 within one module, thus eliminating the need to transfer wafer 20 from a cleaning module to a different drying module. Apparatus 10 comprises a wafer carrier 12, which is configured to hold wafer 20 during the cleaning and drying processes of the present invention. Wafer carrier 12 may comprise any suitable wafer carrier or platform known and used in the semiconductor industry. In one embodiment of the present invention, wafer carrier 12 comprises wafer chucks 16 upon which wafer 20 rests. Wafer carrier 14 and/or wafer chucks 16 may be coupled to a drive assembly 18, which is configured to effect movement of the wafer 20. The movement of wafer 20 may be linear, orbital, rotational or a mixture of linear, orbital, and/or rotational. In a preferred embodiment of the invention, drive assembly 18 effects rotational movement of the wafer.

Apparatus 10 further comprises a press plate 14 having a first surface 24. First surface 24 of press plate 14 may be formed of any suitable material that is not adversely affected by the cleaning and/or drying fluids used during the cleaning and drying process, as described in more detail below. Examples of suitable materials from which first surface 24 of press plate 14 may be formed include, ceramic materials, quartz, and metals and metallic alloys coated with an inert polymer, such as, for example, TEFLON®. Press plate 14 is connected to actuators 22, which raise and lower press plate 14 relative to wafer carrier 12 and wafer 20 so that a wafer can be positioned on wafer carrier 12 before the cleaning and drying processes and can be maintained a predetermined distance from first surface 24 of press plate 14 during the cleaning and drying process, as described in more detail below. Press plate 14 is disposed coaxially with wafer 20 and is approximately at least as large as wafer 20 to minimize edge effects that may occur during cleaning and drying and to minimize the amount of cleaning fluid mist and other particulates that may redeposit on surface 32 of wafer 20 during the cleaning and drying processes.

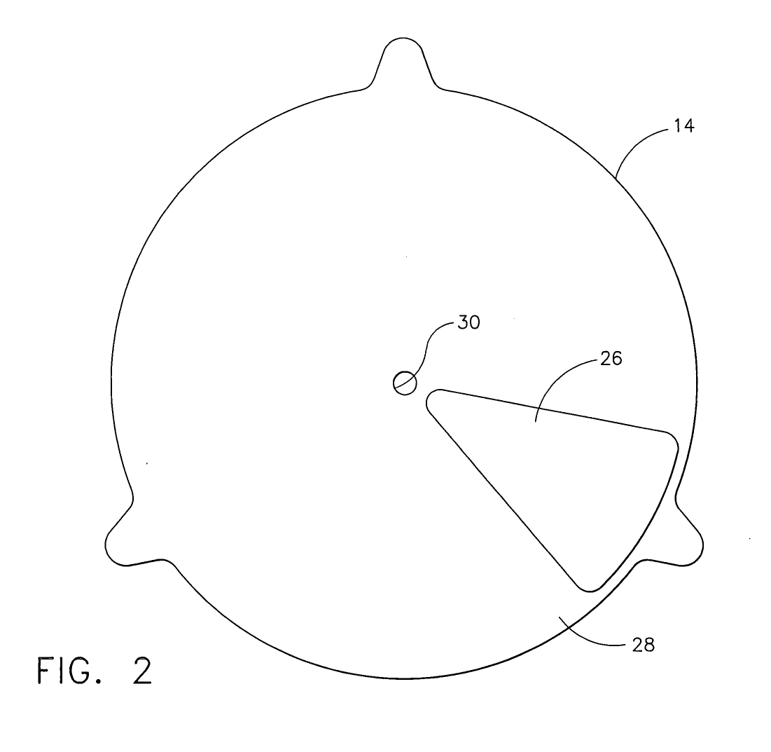

As illustrated in FIGS. 1 and 2, press plate also has a fluid port 30 through which the cleaning and/or drying fluids used during the cleaning and drying processes may be dispensed to wafer 20. In one embodiment of the invention, press plate 14 has one fluid port 30 through which both the cleaning and the drying fluids are dispensed to the wafer. However, it will be understood that press plate 14 may comprise two or more fluid ports through which various cleaning and drying fluids may be dispensed.

At least one mega-sonic transducer 26 is disposed on a second surface 28 of press plate 14. Mega-sonic transducer 26 may comprise any suitable sonic transducer as used in the semiconductor industry. The mega-sonic transducer 26 may be the size of the entire second surface 28 of press plate 14 or may disposed proximate to only a portion of the second surface 28 of press plate 14, as illustrated in FIGS. 1 and 2. During the cleaning process of the present invention, mega-sonic transducer 26 produces acoustic energy which is transmitted by press plate 14, acting as the mega-sonic applicator, to a cleaning fluid used during the cleaning process. The acoustic energy travels through the cleaning fluid and dislodges particulates from the surface 32 of wafer 20. Mega-sonic transducer 26 may emit one or more wavelengths to facilitate the cleaning of surface 32 of wafer 20. Mega-sonic transducer 26 also may emit acoustic energy at suitable wavelengths that travel through wafer 20 to clean a second surface 36 of wafer 20.

In another exemplary embodiment of the present invention, mega-sonic transducer 26 also may be of the type that can measure the impedance from acoustic energy reflected back from first surface 32 and/or second surface 36 of wafer 20. In this manner, once the impedance is measured, the distance between first surface 24 of press plate 14 and first surface 32 of wafer 20 may be increased or decreased before or during cleaning to enhance cleaning efficiency. In addition, mega-sonic transducer 26 may measure the impedance to determine if wafer 20 is suitably positioned on wafer carrier 12, if wafer 20 is broken or damaged, if wafer 20 has fallen from wafer carrier 12, and the like.

In another exemplary embodiment of the invention, a plurality of mega-sonic transducers 26 may be disposed on second surface 28 of press plate 14. The mega-sonic transducers 26 may be independent of each other or may be connected to each other in series or parallel. The plurality of mega-sonic transducers may be configured to provide various cleaning efficiencies at different areas of first surface 24 of press plate 14. In addition, each of the mega-sonic transducers 26 may emit acoustic energy at a suitable wavelength or wavelengths so that both the first surface 32 and second surface 36 of wafer 20 are cleaned.

A cleaning and drying process using apparatus 10 will now be described with reference to FIG. 1. A wafer 20 having a surface 32 to be cleaned is suitably positioned on wafer carrier 12. Apparatus 10 is configured so that, during cleaning and drying, a predetermined distance is maintained between wafer 20 and press plate 14, as discussed in more detail below. In one embodiment of the invention, press plate 14 is positioned suitably above wafer carrier 12 so that wafer 20 can be positioned safely on wafer carrier 12. Press plate 14 then is lowered by actuators 22 so that press plate 14 is maintained at the predetermined distance from wafer carrier 12 and/or wafer 20 during cleaning and drying. In another embodiment of the invention, press plate 14 is disposed at a fixed location and wafer carrier 12 is lowered below press plate 14 so that wafer 20 can be positioned on wafer carrier 12. Wafer carrier 12 then is raised proximate to press plate 14 so that wafer carrier 12 and/or wafer 20 is maintained at the predetermined distance from press plate 14 during cleaning and drying. Preferably, press plate 14 and wafer 20 are disposed coaxially.

After wafer 20 is suitably situated between wafer carrier 12 and press plate 14, and preferably after wafer carrier 12 and press plate 14 are situated a predetermined distance from each other, at least one cleaning fluid 34 is dispensed through fluid port 30 of press plate 14 at a predetermined flow rate to wafer 20. Cleaning fluid 34 may be any suitable cleaning fluid known and used in the semiconductor industry, such as acids, bases, surfactants and chelating agents, and can also comprise de-ionized water. In addition, any suitable number of cleaning fluids may be used sequentially. For example, an acidic cleaning fluid may be used initially to clean the wafer surface, followed by a de-ionized water rinse. While the present invention contemplates that port 30 may be situated at any suitable location within press plate 14, preferably port 30 is situated at or sufficiently close to the center of press plate 14 so that cleaning fluid 34 flows uniformly radially from approximately the center of wafer 20 to its edges upon rotation. During or after dispensing of cleaning fluid 34, drive assembly 18 rotates wafer carrier 12 and/or wafer chucks 16 so that wafer 20 is rotated about its central axis.

During the cleaning of wafer 20, mega-sonic transducer 26 is activated. Mega-sonic transducer 26 produces acoustic energy that is transmitted by presser plate 14 to cleaning fluid 34. The acoustic energy travels through cleaning fluid 34 and causes particulates to be dislodged from first surface 32 of wafer 20. Mega-sonic transducer 26 may also produce acoustic energy that travels through wafer 20 to dislodge particulates from second surface 36 of wafer 20. In addition, mega-sonic transducer 26 may measure the impedance reflected back from first surface 32 and/or second surface 36 of wafer 20. Depending on the measured impedance, the distance between first surface 24 of press plate 14 and wafer 20 may be increased or decreased to enhance the cleaning process.

The speed of rotation of the wafer, the flow rate of cleaning fluid 34, and the distance between wafer 20 and press plate 14 are such that a layer of cleaning fluid 34 is provided, and a meniscus of cleaning fluid 34 is maintained, between first surface 32 of wafer 20 and first surface 24 of press plate 14. The wafer is rotated at a speed that is sufficient to cause cleaning fluid 34 to uniformly spread from port 30 to the edge of the wafer but is not so high that it overcomes the surface tension forces of cleaning fluid 34 and causes cleaning fluid 34 to be flung from the wafer under the influence of centrifugal forces. In one embodiment of the invention, the speed of rotation of the wafer is in the range of about 5 rpm to about 70 rpm. In another embodiment of the invention, the speed of rotation of the wafer is in the range of about 5 rpm to about 50 rpm. In a preferred embodiment of the invention, the speed of rotation of the wafer is about 20 rpm.

The minimum distance that may be maintained between first surface 24 of press plate 14 and surface 32 of wafer 20 during cleaning and drying depends, in part, on the flatness of surface 32 of wafer 20. Accordingly, first surface 24 of press plate 14 is maintained at a sufficient distance from wafer 20 so that press plate 14 does not make contact with wafer 20. The maximum distance that may be maintained between first surface 24 of press plate 14 and surface 32 of wafer 20 variously depends, in part, on the flow rate of cleaning fluid 34 and rotation of wafer 20. The maximum distance is the greatest distance that still maintains a meniscus of cleaning fluid between first surface 24 of press plate 14 and first surface 32 of wafer 20. In one exemplary embodiment of the present invention, for example, the distance between first surface 24 of press plate 14 and first surface 32 of wafer 20 may be in the range of approximately 0.1 mm to approximately 4.0 mm. In a preferred embodiment of the present invention, the distance between first surface 24 of press plate 14 and first surface 32 of wafer 20 may be in the range of approximately 0.2 mm to approximately 3.5 mm. In a more preferred embodiment of the present invention, the distance between first surface 24 of press plate 14 and first surface 32 of wafer 20 may be approximately 2.0 mm. The distance between surface 24 of press plate 14 and first surface 32 of wafer 20 also may be increased or decreased during cleaning to facilitate the cleaning process.

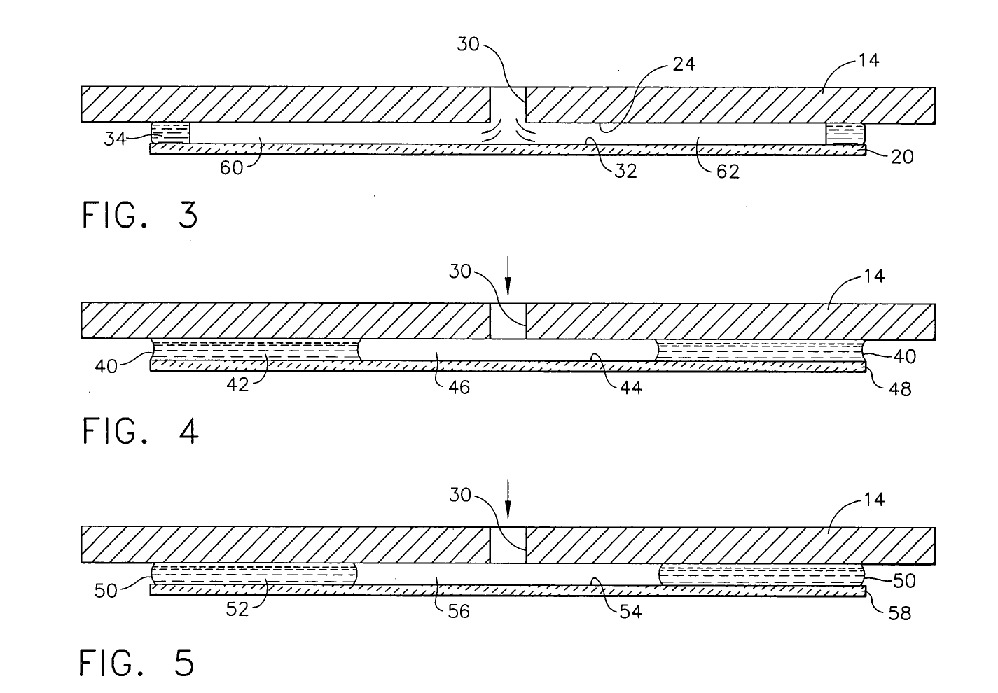

Referring now to FIG. 3, after a sufficient cleaning time, the flow of cleaning fluid 34 through port 30 is terminated and a drying fluid 60 is dispensed through a drying fluid port in presser plate 14 to surface 32 of wafer 20. The drying fluid 60 may be any suitable gas or vapor that does not adversely affect the wafer surface, such as, for example, nitrogen gas. In a preferred embodiment of the invention, drying fluid 60 is a vapor of material that can diffuse into cleaning fluid 34 and reduce the surface tension of the cleaning fluid. Examples of suitable vapors include, but are not limited to, isopropyl alcohol vapor and acetone vapor. While the present invention contemplates that the drying fluid port may be disposed at any suitable location within press plate 14, in a preferred embodiment of the invention, the drying fluid port is situated sufficiently close to the center of press plate 14 so that the drying fluid 60 forms a bubble 62 that grows uniformly radially from approximately the center of wafer 20 to its edges as the drying fluid 60 flows through the drying fluid port. In a more preferred embodiment of the invention, the drying fluid port is port 30. FIG. 4 illustrates a meniscus 40 of a cleaning fluid 42 and a bubble 46 of a drying fluid disposed between a hydrophilic wafer surface 44 of a wafer 48 and a press plate 14. FIG. 5 illustrates a meniscus 50 of a cleaning fluid 52 and a bubble 56 of the drying fluid disposed between a hydrophobic wafer surface 54 of a wafer 58 and a press plate 14.

Referring again to FIG. 3, as the flow of drying fluid 60 through press plate 14 continues, bubble 62 continues to grow substantially radially, forcing cleaning fluid 34 from surface 32 of wafer 20. The drying fluid 60 flows to surface 32 of wafer 20 at a rate that permits bubble 62 to grow substantially uniformly. In addition, if drying fluid 60 comprises any material that may decrease the surface tension of cleaning fluid 34, the flow of drying fluid 60 is at a rate that permits the material to diffuse into cleaning fluid 34. A flow rate that meets these parameters may achieve uniform drying of surface 32 of wafer 20 with minimal residue formation. In one exemplary embodiment of the invention, the flow rate of drying fluid 60 is in the range of approximately 10 to 100 ml/sec. In a preferred embodiment of the invention, the flow rate of drying fluid 60 is in the range of approximately 25 to 75 ml/sec. In a more preferred embodiment of the invention, the flow rate of drying fluid 60 is approximately 50 ml/sec. In addition, it will be understood that the flow rate of drying fluid 60 may be increased or decreased to enhance the drying process. The distance between first surface 24 of press plate 14 and first surface 32 of wafer 20 also may be increased or decreased during drying to facilitate the drying process.

Drying may be terminated once cleaning fluid 34 is substantially removed from surface 32 of wafer 20 by drying fluid 60. The drying time may be calculated based on the size of wafer 20, the flow rate of drying fluid 60, and the distance between wafer 20 and press plate 14. In one embodiment of the invention, drying fluid 60 may be dispensed between first surface 32 of wafer 20 and first surface 24 of press plate 14 so that the drying process continues for at least 2 seconds. In a preferred embodiment of the invention, drying fluid 60 may be dispensed between first surface 32 of wafer 20 and first surface 24 of press plate 14 so that the drying process continues for at least 5 seconds. In a more preferred embodiment of the invention, drying fluid 60 may be dispensed between first surface 32 of wafer 20 and first surface 24 of press plate 14 for at least 10 seconds.

As will be appreciated, because press plate 14 is disposed closely to surface 34 of wafer 20 during cleaning and drying, apparatus 10 minimizes the amount of cleaning fluid required to suitably clean wafer 20, as little more than an amount sufficient to fill the volume of space between the surface 34 of wafer 20 and surface 24 of press plate 14 may be needed. In addition, apparatus 10 minimizes the amount of drying fluid required to suitably clean wafer 20, as, again, little more than an amount sufficient to fill the volume of space between the first surface 32 of wafer 20 and surface 24 of press plate 14 may be needed. Because the cleaning fluid and/or drying fluid may comprise materials that are environmentally regulated, minimizing the amount of cleaning and/or drying fluids may make the cleaning and drying processes more environmentally feasible. Moreover, because the cleaning and drying fluids cover first surface 32 of wafer 20 during the cleaning and drying processes, the apparatus of the present invention provides an anaerobic environment to which surface 34 of wafer 20 is exposed. This anaerobic environment may minimize or eliminate corrosion of the wafer due to exposure to oxygen. This configuration also may minimize photogalvonic corrosion, which otherwise may occur from photons impinging on the wafer surface 32. In addition, because press plate 14 is of a size at least as large as wafer 20, this exemplary embodiment of the invention minimizes the redeposition of moisture, such as cleaning fluid mist, and other particulates on surface 32 of wafer 20.

While the above description contemplates wafer carrier 12 moving wafer 20 relative to press plate 14, it will be appreciated that wafer 20 and press plate 14 both may be rotated, preferably in the same direction. Further, while FIGS. 1 and 3-5 illustrate apparatus 10 with press plate 14 disposed above wafer 20, in an alternative embodiment of the invention, the cleaning and drying apparatus of the present invention may comprise a wafer carrier disposed above a press plate that is configured to move relative to the wafer. The wafer carrier may be positioned above the press plate so that, prior to cleaning and drying, the wafer can be positioned suitably within the wafer carrier, which then may be lowered so that the wafer surface is maintained at a predetermined distance from the press plate during cleaning and drying. In another embodiment of the invention, the wafer carrier may be disposed at a fixed location and the press plate may be lowered below the wafer carrier so that the wafer can be suitably positioned within the wafer carrier. The press plate then may be raised proximate to wafer carrier so that the press plate is maintained at a predetermined distance from the wafer carrier during cleaning and drying. The press plate then may be rotated during cleaning and drying or, alternatively, both the press plate and the wafer may be rotated during cleaning and drying.

In another exemplary embodiment of the invention, the movement of wafer 20, press plate 14, or both, and/or the flow rate of the drying fluid may be varied during the drying process to regulate the growth of the bubble of drying fluid between wafer 20 and press plate 14. In this manner, the bubble may be permitted to grow uniformly or at varying rates so that uniform drying of surface 32 of wafer 20 may be achieved regardless of the topology of the wafer surface or the surface tension of the cleaning fluid.

In a further exemplary embodiment of the invention, first surface 24 of press plate 14 may be formed of a hydrophilic material, which may facilitate the wetting of the wafer surface by the cleaning fluid. Alternatively, first surface 24 of press plate 14 may be formed of a hydrophobic material or of a combination of hydrophobic and hydrophilic materials to facilitate or enhance the cleaning and drying processes.

In yet another exemplary embodiment of the invention, first surface 24 of press plate 14 may be substantially planar. In an alternative embodiment of the present invention, surface 24 of press plate 14 may have various topologies. For example, the press plate surface 24 may be substantially convex or substantially concave, or may be convex and concave depending on the radial distance from the center of the press plate. In addition, the press plate surface may be conical, may be thinner at its edges, may be thicker at its edges, or may have any other suitable topography or geography the facilitates cleaning and/or drying. The various topologies may compensate for various inconsistencies in the cleaning and/or drying process, such as, for example, a non-planar wafer surface or a wafer surface comprising both hydrophilic and hydrophobic materials.

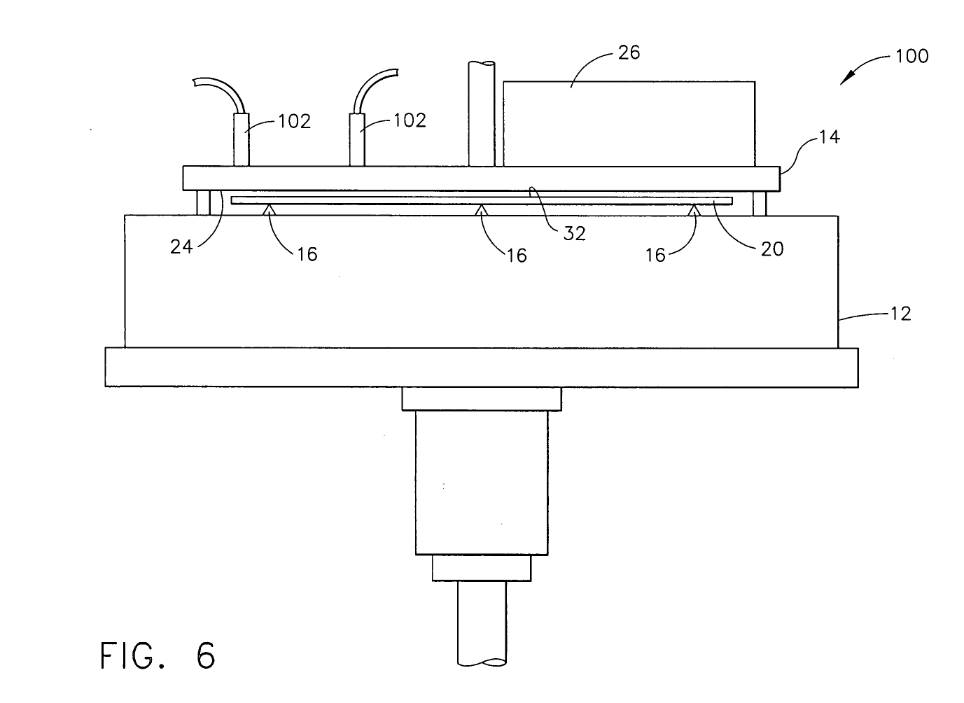

Referring to FIG. 6, an apparatus 100 in accordance with another exemplary embodiment of the present invention is illustrated. Apparatus 100 is similar to apparatus 10, with like numerals representing like elements, although apparatus 100 further comprises at least one electrical conductor 102. Electrical conductor 102 is coupled to press plate 14 to apply an electrostatic force to press plate 14. In this manner, at least a portion of first surface 24 of press plate 14 may exhibit an electrical charge that may attract and bind to press plate 14 particulates that are released from surface 32 of wafer 20 during cleaning. One or more electrical conductors 102 may cause first surface 24 of press plate 14 to exhibit one electrical charge throughout the cleaning and drying process or, alternatively, may cause portions of first surface 24 of press plate 14 to exhibit different electrical charges throughout the cleaning and drying process to attract various charged particulates. In yet another embodiment of the invention, one or more electrical conductors 102 may cause surface 24 of press plate 14 to exhibit one or more electrical charges at one point during cleaning and/or drying and one or more different electrical charges at another point during cleaning and/or drying.

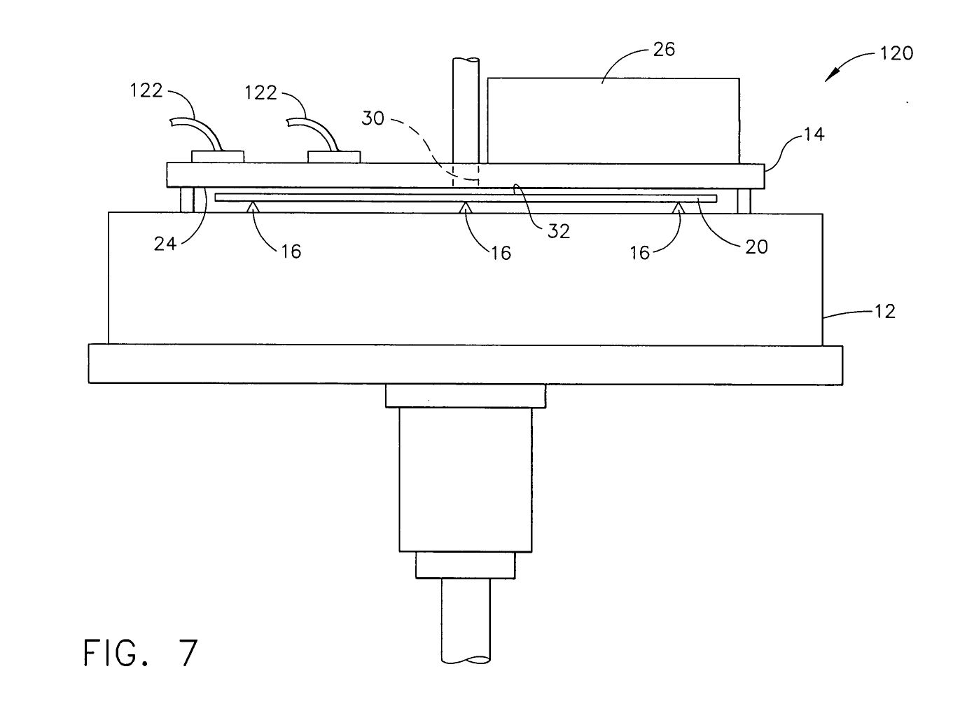

Referring to FIG. 7, an apparatus 120 in accordance with a further exemplary embodiment of the present invention is illustrated. Apparatus 120 is similar to apparatus 10, with like numerals representing like elements, although apparatus 120 further comprises at least one thermal control unit 122. Thermal control unit(s) 122 is coupled to press plate 14 so that the temperature of press plate 14 may be regulated to accelerate or decelerate the cleaning and/or drying processes. One or more thermal control units 122 may cause first surface 24 of press plate 14 to exhibit one temperature over first surface 24 of press plate 14 or to exhibit two or more temperatures over first surface 24 of press plate 14, for example, to compensate for a combination of hydrophilic and hydrophobic materials that may form first surface 32 of wafer 20. In yet another embodiment of the invention, one or more thermal control units 122 may cause surface 24 of press plate 14 to exhibit one or more temperatures at one point during cleaning and/or drying and one or more different temperatures at another point during cleaning and/or drying.

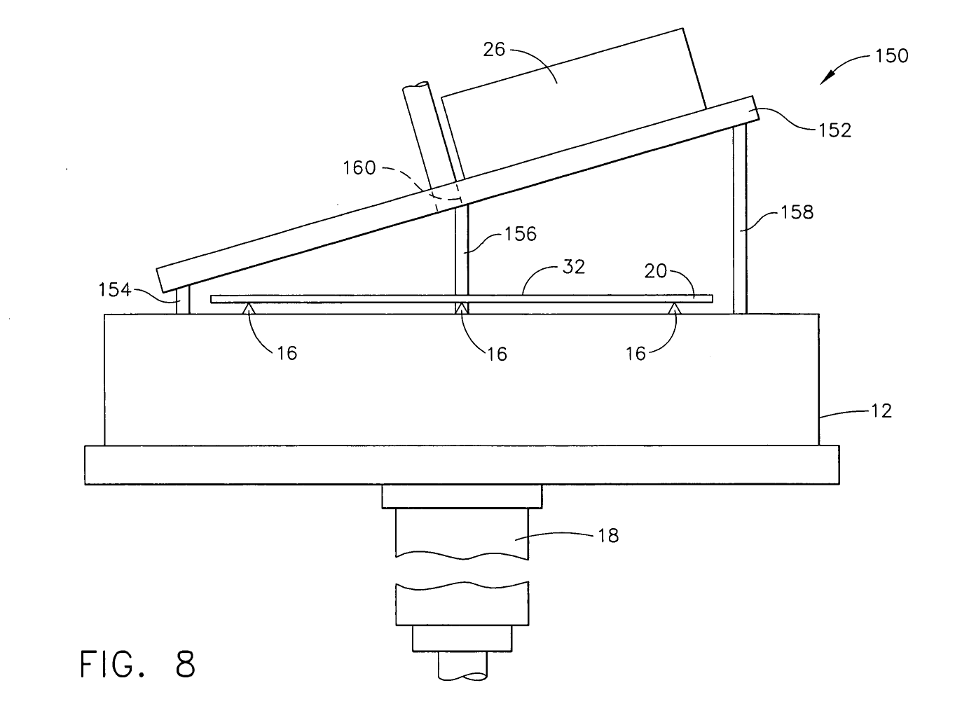

Referring now to FIG. 8, an apparatus 150 in accordance with yet another exemplary embodiment of the present invention is illustrated. Apparatus 150 is similar to apparatus 10, with like numerals representing like elements, although apparatus 150 further comprises a press plate 152 that may move pivotally relative to a wafer 20. Press plate 152 may be formed of any of the materials and have any of the topologies and geometries as described above with reference to press plate 14 of FIG. 1. Press plate 152 may be moved pivotally by actuators 154, 156, and 158, which are connected at one end to press plate 154 and at another end to wafer carrier 12. In one embodiment of the invention, during loading of wafer carrier 12 with wafer 20, at least one actuator of actuators 154-158 may extend vertically, causing press plate 152 to tilt, thereby allowing wafer carrier 12 to be loaded. Once wafer 20 is suitably mounted on wafer carrier 12, a cleaning fluid may be deposited through a port 160, or by any other suitable dispenser, onto wafer 20 and the extended actuators may lower press plate 152 until press plate 152 is substantially parallel to wafer 20. In this manner, the lowering of press plate 152 produces a “squeezing” action of the cleaning fluid, squeezing any air bubbles that may be trapped in the cleaning fluid to the ambient environment. The presence of air bubbles in the cleaning fluid may adversely affect the efficiency of the cleaning process by interfering with the transmission of the acoustic energy from mega-sonic transducer 26. Press plate 152 may also be tilted during the cleaning process to modify the transmission of the acoustic energy to compensate for irregularities of first surface 32 of wafer 20 or to compensate for the various materials used to form first surface 32. In addition, press plate 152 may be pivoted relative to wafer 20 after the drying process to prevent any residual moisture or other particulates disposed on first surface 24 of press plate 14 from dripping onto wafer 20. It will be understood that any other suitable mechanism or device may be used to cause press plate 152 to move pivotally in relation to wafer 20. For example, in another embodiment of the invention, press plate 152 may be connected to a hinge assembly that causes press plate 152 to move pivotally in relation to wafer 20.

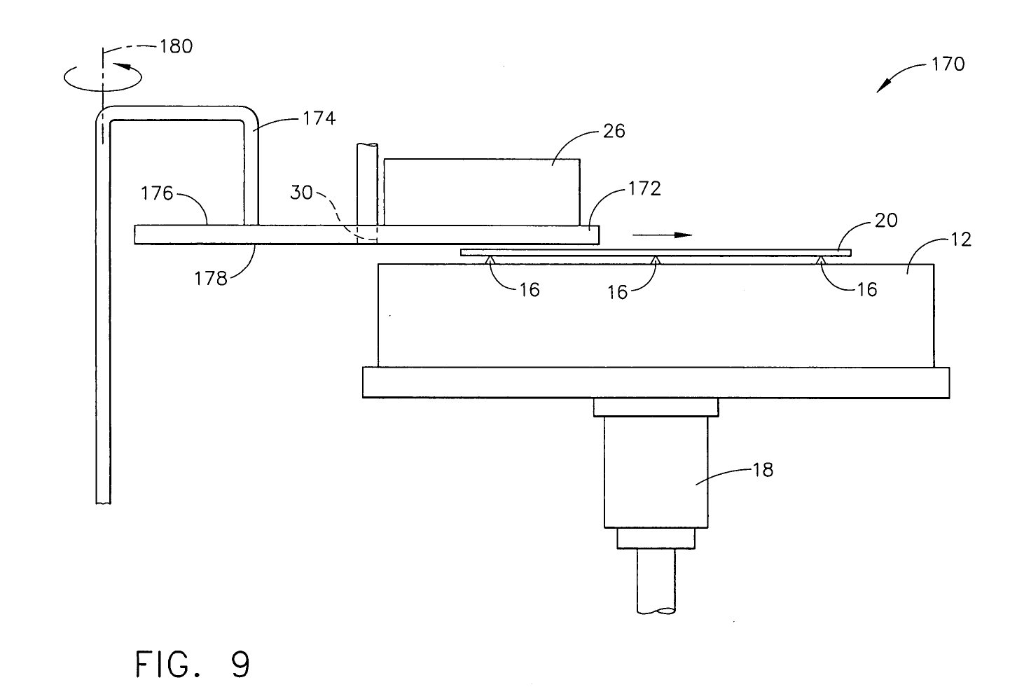

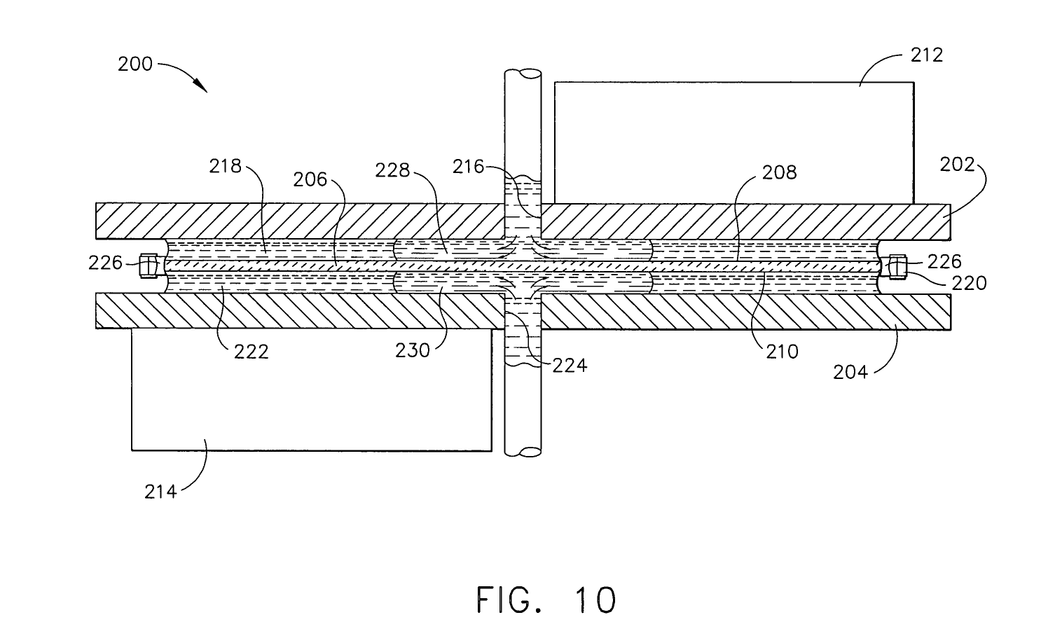

FIG. 9 illustrates an apparatus 170 in accordance with a further exemplary embodiment of the present invention. Apparatus 170 is similar to apparatus 10, with like numerals representing like elements, although apparatus 170 further comprises a press plate 172 that may move laterally relative to wafer 20. Press plate 172 may be formed of any of the materials and have any of the topologies and geometries as described above with reference to press plate 14 of FIG. 1. Press plate 172 may be moved laterally by any suitable motion assembly. For example, a second surface 176 of press plate 172 may be connected to an actuator 174 that is configured to rotate press plate 172 about an axis 180 so that press plate may move substantially laterally relative to wafer 20. In one embodiment of the invention, during loading of wafer carrier 12 with wafer 20, actuator 174 may rotate press plate 172 about axis 180 so that it is remote from wafer carrier 12, thereby allowing wafer carrier 12 to be loaded. Once wafer 20 is suitably mounted on wafer carrier 12, a cleaning fluid may be deposited onto wafer 20 and actuator 174 then may rotate press plate 172 about axis 180 so that a first surface 178 of press plate 172 is disposed above wafer 20. Alternatively, as press plate 172 moves laterally relative to wafer 20, it may dispense cleaning fluid on wafer 20. In another embodiment of the invention, press plate 172 may be connected to a translator assembly that causes press plate 152 to move in a linear, lateral motion relative to wafer 20. The lateral movement of press plate 172 relative to wafer 20 in the presence of cleaning fluid produces a “shearing” action of the cleaning fluid, which may reduce or eliminate air bubbles that may be trapped in the cleaning fluid. In addition, press plate 172 may be moved laterally relative to wafer 20 after the drying process to prevent any residual moisture or other particulates disposed on surface 24 of press plate 14 from dripping onto wafer 20. It will be understood that any other suitable mechanism or device may be used to cause press plate 152 to move laterally in relation to wafer 20. It will be understood that, while apparatus 170 is illustrated with press plate 172 disposed above wafer carrier 12, wafer carrier 12 may be disposed above press plate 172.

FIG. 10 illustrates an apparatus 200 in accordance with another exemplary embodiment of the present invention. Apparatus 200 comprises an upper press plate 202 and a lower press plate 204. During cleaning and drying, a wafer 206 may be supported by rotating members 226 of a wafer carrier 220 that interposes wafer 206 between upper press plate 202 and lower press plate 204 and rotates wafer 206 so that a first surface 208 and a second surface 210 of wafer 206 both can be cleaned and dried. A first mega-sonic transducer 212 may be connected to upper press plate 202 and a second mega-sonic transducer 214 may be connected to lower press plate 204. A first cleaning fluid 218 may be disposed through a first port 216 of upper press plate 202 and a second cleaning fluid 222 may be disposed through a second port 224 of lower press plate 204. Cleaning fluid 218 and cleaning fluid 222 may be composed of the same or different cleaning chemistries. During the drying process, a first drying fluid 228 may be disposed between wafer 206 and upper press plate 202, preferably through first port 216, although any suitable port disposed substantially at the center of upper press plate 202 may be used. Similarly, a second drying fluid 230 may be disposed between wafer 206 and lower press plate 204, preferably through second port 224, although any suitable port disposed substantially at the center of lower press plate 204 may be used. Upper press plate 202 and lower press plate 204 may have any of the features, characteristics or qualities described above with reference to press plate 14 of FIGS. 1, 6 and 7, press plate 152 of FIG. 8, or press plate 172 of FIG. 9. Accordingly, cleaning and drying between upper press plate 202 and wafer 206 and between lower press plate 204 and wafer 206 may proceed as described above.

Thus, processes and apparatus for efficiently cleaning and drying a work piece in a single apparatus are provided. The processes and apparatus of the invention utilize a press plate disposed a distance from the work piece during cleaning and drying forming a space between the two. During cleaning, the press plate, the work piece, or both, is set in motion and a cleaning fluid is dispensed to substantially fill the space between the press plate and the work piece. After the cleaning process, a drying fluid is dispensed between the press plate and work piece, forcing the cleaning fluid from the work piece surface and drying the work piece surface. Accordingly, cleaning and drying of work piece surfaces formed of hydrophilic materials, hydrophobic materials, or both, may be effectively cleaned and dried in one apparatus. In addition, cleaning and drying of the work piece surface is achieved with minimal use of cleaning and drying fluids.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. An apparatus for cleaning and drying a work piece, the apparatus comprising:
a carrier configured to carry a work piece having a first surface;
a first press plate having a first surface and a second surface, wherein, during a cleaning process, at least one of said carrier and said first press plate is configured to move relative to the other and said first press plate is disposed a first distance from said first surface of said work piece such that, when a cleaning fluid is disposed between said work piece and said first press plate, a surface tension of said cleaning fluid maintains a meniscus between the work piece and said first press plate; and
a first mega-sonic transducer coupled to said second surface of said first press plate.

2. The apparatus for cleaning and drying a work piece of claim 1, said first press plate further comprising a first port configured to dispense a cleaning fluid therethrough to the work piece.

3. The apparatus for cleaning and drying a work piece of claim 2, said first press plate further comprising a second port configured to dispense a drying fluid therethrough to the work piece.

4. The apparatus for cleaning and drying a work piece of claim 3, wherein said first port and said second port are the same port.

5. The apparatus for cleaning and drying a work piece of claim 2, wherein said first port is disposed substantially centrally within said first press plate.

6. The apparatus for cleaning and drying a work piece of claim 3, wherein said second port is disposed substantially centrally within said first press plate.

7. The apparatus of claim 6, wherein said first port and said second port are the same port.

8. The apparatus for cleaning and drying a work piece of claim 1, wherein said first press plate is configured to move at least one of linearly, rotationally, and orbitally.

9. The apparatus for cleaning and drying a work piece of claim 8, wherein said carrier is configured to move the work piece at least one of linearly, rotationally, and orbitally.

10. The apparatus for cleaning and drying a work piece of claim 1, wherein said carrier is configured to move the work piece at least one of linearly, rotationally, and orbitally.

11. The apparatus for cleaning and drying a work piece of claim 10, wherein said carrier is configured to move the work piece rotationally at a speed in the range of about 5 rpm to about 70 rpm.

12. The apparatus for cleaning and drying a work piece of claim 11, wherein said carrier is configured to move the work piece rotationally at a speed in the range of about 5 rpm to about 50 rpm.

13. The apparatus for cleaning and drying a work piece of claim 1, wherein said first press plate is disposed coaxially with the work piece.

14. The apparatus for cleaning and drying a work piece of claim 1, wherein said first surface of said first press plate has a size at least as large as the work piece.

15. The apparatus for cleaning and drying a work piece of claim 1, wherein said first press plate is disposed above said carrier.

16. The apparatus for cleaning and drying a work piece of claim 15, wherein said first press plate is configured to move substantially vertically relative to said carrier.

17. The apparatus for cleaning and drying a work piece of claim 15, wherein said carrier is configured to move substantially vertically relative to said first press plate.

18. The apparatus for cleaning and drying a work piece of claim 1, wherein said carrier is disposed above said first press plate.

19. The apparatus for cleaning and drying a work piece of claim 18, wherein said first press plate is configured to move substantially vertically relative to said carrier.

20. The apparatus for cleaning and drying a work piece of claim 18, wherein said carrier is configured to move substantially vertically relative to said first press plate.

21. The apparatus for cleaning and drying a work piece of claim 1, wherein said first mega-sonic transducer is configured to transmit acoustic energy at a plurality of wavelengths.

22. The apparatus for cleaning and drying a work piece of claim 1, further comprising a second mega-sonic transducer coupled to said second surface of said first press plate, said first mega-sonic transducer configured to transmit acoustic energy at a first wavelength and said second mega-sonic transducer configured to transmit acoustic energy at a second wavelength.

23. The apparatus for cleaning and drying a work piece of claim 1, wherein said first distance is in the range of about 0.1 mm to about 4.0 mm.

24. The apparatus for cleaning and drying a work piece of claim 23, wherein said first distance is in the range of about 0.2 mm to about 3.5 mm.

25. The apparatus for cleaning and drying a work piece of claim 1, wherein said first surface of said first press plate is substantially planar.

26. The apparatus for cleaning and drying a work piece of claim 1, wherein at least a portion of said first surface of said first press plate is at least one of convex, concave, and conical.

27. The apparatus for cleaning and drying a work piece of claim 1, further comprising a first electrical conductor coupled to said first press plate and configured to cause at least a first portion of said first press plate to exhibit a first electrical charge.

28. The apparatus for cleaning and drying a work piece of claim 27, further comprising a second electrical conductor coupled to said first press plate and configured to cause a second portion of said first press plate to exhibit a second electrical charge.

29. The apparatus for cleaning and drying a work piece of claim 1, further comprising a first thermal control unit coupled to said first press plate and configured to regulate a temperature of at least a first portion of said first press plate.

30. The apparatus for cleaning and drying a work piece of claim 29, further comprising a second thermal control unit coupled to said first press plate and configured to regulate a second portion of said first press plate.

31. The apparatus for cleaning and drying a work piece of claim 1, further comprising a pivoting assembly configured to move said first press plate pivotally relative to the work piece.

32. The apparatus for cleaning and drying a work piece of claim 1, further comprising a moving assembly configured to move said fist press plate substantially laterally relative to the work piece.

33. The apparatus for cleaning and drying a work piece of claim 1, further comprising a second press plate disposed a second distance from a second surface of the work piece such that a surface tension of a cleaning fluid disposed between said second surface of the work piece and said second press plate maintains a meniscus between the work piece and said second press plate.

34. The apparatus for cleaning and drying a work piece of claim 33, wherein at least one of said carrier and said second press plate is configured to move relative to the other.

35. A method for cleaning and drying a work piece, the method comprising the steps of:
loading a work piece carrier with a work piece having a first surface;
providing a first press plate having a first surface and a first port;
positioning at least one of said first press plate and said work piece carrier a first distance relative to the other such that a space having a volume is formed between said first surface of said work piece and said first surface of said press plate;
moving at least one of said first press plate and said work piece at least one of linearly, rotationally, and orbitally;
dispensing a first cleaning fluid between said work piece and said first press plate to substantially fill said volume of said space;
transmitting sonic energy through said first cleaning fluid; and
flowing a first drying fluid through said first port to said first surface of said work piece.

36. The method for cleaning and drying a work piece of claim 35, the step of moving comprising rotating said work piece at a speed in the range of about 5 rpm to about 70 rpm.

37. The method for cleaning and drying a work piece of claim 36, the step of moving comprising rotating said work piece at a speed in the range of about 5 rpm to about 50 rpm.

38. The method for cleaning and drying a work piece of claim 35, the step of moving comprising moving said first press plate and said work piece at least one of linearly, rotationally, and orbitally.

39. The method for cleaning and drying a work piece of claim 35, the step of positioning further comprising positioning at least one of said first press plate and said work piece so that said first press plate and said work piece are coaxial.

40. The method for cleaning and drying a work piece of claim 35, the step of positioning comprising the step of moving said first press plate substantially vertically relative to said work piece.

41. The method for cleaning and drying a work piece of claim 35, the step of positioning comprising the step of moving said work piece substantially vertically relative to said first press plate.

42. The method for cleaning and drying a work piece of claim 35, the step of positioning comprising positioning said first press plate above said work piece carrier.

43. The method for cleaning and drying a work piece of claim 35, the step of positioning comprising positioning said work piece carrier above said first press plate.

44. The method for cleaning and drying a work piece of claim 35, the step of positioning comprising positioning at least one of said first press plate and said work piece so that said first distance is in the range of about 0.1 mm to about 4.0 mm.

45. The method for cleaning and drying a work piece of claim 35, the step of positioning comprising positioning at least one of said first press plate and said work piece so that said first distance is in the range of about 0.2 mm to about 3.5 mm.

46. The method for cleaning and drying a work piece of claim 35, wherein said step of dispensing comprises dispensing said cleaning fluid through said first port before said step of flowing said drying fluid through said first port.

47. The method for cleaning and drying a work piece of claim 35, further comprising the step of regulating a temperature of at least a portion of said first surface of said first press plate during at least one of said steps of dispensing and transmitting.

48. The method for cleaning and drying a work piece of claim 35, further comprising the step of applying an electrostatic force to at least a portion of said first surface of said first press plate so that said at least a portion of said first surface of said first press plate exhibits an electrical charge.

49. The method for cleaning and drying a work piece of claim 35, further comprising the step of measuring an impedance of said sonic energy and the step of positioning at least one of said first press plate and said work piece carrier a second distance relative to the other based on said impedance.

50. The method for cleaning and drying a work piece of claim 35, the step of transmitting comprising transmitting sonic energy at a first wavelength.

51. The method for cleaning and drying a work piece of claim 35, the step of transmitting comprising transmitting sonic energy at a plurality of wavelengths.

52. The method for cleaning and drying a work piece of claim 35, the step of flowing comprising flowing a drying fluid comprising isopropyl alcohol vapor between said work piece and said first press plate.

53. The method for cleaning and drying a work piece of claim 35, the step of flowing comprising flowing said drying fluid at a flow rate in the range of about 10 ml/sec. to about 100 ml/sec.

54. The method for cleaning and drying a work piece of claim 35, the step of flowing comprising flowing said drying fluid to said first surface of said work piece at a plurality of flow rates.

55. The method for cleaning and drying a work piece of claim 35, the step of positioning comprising pivoting said first press plate relative to said work piece.

56. The method for cleaning and drying a work piece of claim 35, the step of positioning comprising moving said first press plate substantially laterally relative to said work piece.

57. The method for cleaning and drying a work piece of claim 35, wherein said work piece has a second surface and the method further comprises the steps of:
providing a second press plate having a first surface and a first port;
positioning at least one of said second press plate and said work piece carrier a second distance relative to the other such that a space having a volume is formed between said second surface of said work piece and said first surface of said second press plate;
moving at least one of said second press plate and said work piece at least one of linearly, rotationally, and orbitally;
dispensing a second cleaning fluid between said work piece and said second press plate to fill said volume of said space formed between said second surface of said work piece and said first surface of said second press plate;
transmitting sonic energy through said second cleaning fluid; and
flowing a second drying fluid through said first port of said second press plate.

58. An apparatus for cleaning and drying a semiconductor wafer, comprising:
a fixture for holding the wafer;
a plate disposed proximate to the wafer and maintained a distance from the wafer, said plate comprising a first port for injecting a cleaning fluid between said plate and the wafer during a first interval, and a second port for subsequently injecting a drying medium between said plate and the wafer in a second interval;
a driving assembly configured to effect relative motion between the wafer and said plate; and
a mega-sonic transducer mounted on said plate and configured to transmit sonic energy through said cleaning fluid to the wafer during the first interval.

59. The apparatus for cleaning and drying a semiconductor wafer of claim 58, wherein said first port and said second port are the same port.

60. The apparatus for cleaning and drying a semiconductor wafer of claim 59, wherein said first port is disposed substantially centrally within said plate.

61. The apparatus for cleaning and drying a semiconductor wafer of claim 58, wherein said second port is disposed substantially centrally within said plate.

62. The apparatus for cleaning and drying a semiconductor wafer of claim 58, wherein said driving assembly is configured to rotate the wafer.

63. The apparatus for cleaning and drying a semiconductor wafer of claim 58, wherein the driving assembly is configured to rotate said plate.

64. The apparatus for cleaning and drying a semiconductor wafer of claim 58, the apparatus further comprising an actuator assembly that is configured to move said plate pivotally relative to the wafer.

65. The apparatus for cleaning and drying a semiconductor wafer of claim 58, the apparatus further comprising an actuator assembly that is configured to move said press plate laterally relative to the wafer.

66. The apparatus for cleaning and drying a semiconductor wafer of claim 58, the apparatus further comprising at least one electrical conductor coupled to said press plate and configured to apply an electrostatic force to said press plate so that at least a portion of said press plate exhibits an electrical charge.

67. The apparatus for cleaning and drying a semiconductor wafer of claim 58, the apparatus further comprising at least one temperature control unit coupled to said press plate and configured to regulate a temperature of at least a portion of said press plate.

68. The apparatus for cleaning and drying a semiconductor wafer of claim 58, wherein said press plate and said wafer are disposed coaxially.

69. The apparatus for cleaning and drying a semiconductor wafer of claim 58, wherein said press plate has a first surface and said first surface of said press plate is at least as large in size as said wafer.
